(19) United States
(12) Patent Application Publication
(10) Pub. No.: US 2003/0151211 A1
(43) Pub. Date: Aug. 14, 2003

(54) MLS gasket with variable bead stopper layer

(76) Inventors: Colin C. Chen, Barrington, IL (US); Frank W. Popielas, Naperville, IL (US); Edward A. Raden, Downers Grove, IL (US); Jeffery A. Foster, Rolling Meadows, IL (US); Mike Kestly, Bolingbrook, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/350,844

(22) Filed: Jan. 24, 2003

Related U.S. Application Data
(60) Provisional application No. 60/356,250, filed on Feb. 11, 2002.

(51) Int. Cl. F02F 11/00

(52) U.S. Cl. 277/595

(57) ABSTRACT

A cylinder head gasket has a multi-layered steel body that includes a unitary metallic stopper layer interposed between beaded outer layers. The interposed stopper layer has an asymmetrically formed bead defining at least one raised structure that circumferentially and closely surrounds a combustion aperture. Specifically, the bead defines a trough having a series of variations of thickness or widths about its circumferential dimension. An epoxy resin material substantially fills the volume of the trough about its circumferential extent, irrespective of the variable trough depth or width. In the disclosed embodiment, a metal/epoxy hard coating material is placed in and cured in the trough. To the extent that the trough has a varying height or width about its circumference, the hard coating also has a varying height or width about the circumference of the hard coating-filled bead, so as to provide a substantially uniform sealing pressure under predetermined variable conditions including bore distortion and machining tolerances.

### RELATED APPLICATIONS

This application claims the benefit of U.S. Provisional Application Serial No. 60/356,250 filed Feb. 11, 2002 which is hereby incorporated by reference in its entirety.

### BACKGROUND OF THE INVENTION

1. Field of Invention

The present invention relates to improvements in MLS cylinder head gaskets for internal combustion engines, and more particularly to such gaskets having improved stopper layers to provide enhanced sealing about their combustion apertures.

2. Description of the Prior Art

Those skilled in the art will appreciate the issues involved in maintaining a high quality seal between cylinder apertures of a cylinder block in an internal combustion engine and a cylinder head fastened to the block. In recent years, multiple-layered steel (MLS) cylinder head gaskets have become a preferred design choice, wherein all (typically at least three) gasket layers have been formed of steel. Beaded exterior layers have generally been fabricated from a 301 stainless steel, a robust metal with a relatively high spring rate, for meeting requisite performance requirements over the useful life of the gaskets. The center layer, also called a “spacer” layer, has generally been formed of less expensive metals such as 409 stainless steel, or in some cases even zinc-plated low carbon steels, for meeting less rigorous requirements.

Areas immediately adjacent the circumference of engine cylinder bores are subject to considerably greater stresses for assuring proper sealing than areas of the gasket radially remote from the apertures. To meet the greater stress requirements at the aperture areas, so-called stopper layers have been employed in areas that circumferentially surround each cylinder aperture boundary. The stopper layers are designed to provide increased sealing pressures around the noted areas immediately adjacent the combustion apertures. In some cases the stoppers have been formed of extra layers of metal, consisting either of layers folded over or under primary sealing layers. In other cases, the stoppers have been formed as layers separately provided, e.g., discrete annular rings positioned about the aperture boundaries.

Radially outwardly of the stopper layer, a secondary seal is normally provided. The secondary seal is usually formed as an active spring seal defined by an embossed bead in a primary external sealing layer. Two of such embossed beads are normally provided in two separate mirror image external layers that sandwich the center or spacer layer.

In some cases, the embossed beads employed in such duplicate mirror image primary sealing layers have been prone to cracking at the boundaries of the beads, particularly where hard metal stopper layers have been employed. The stopper layer dynamics can create stresses on the beads that exceed normal bead deflection stress capability. Resultant cold working and bead cracking are issues that are seriously detrimental to both the performance and longevity of gaskets that otherwise provide reliable combustion gas sealing media. To the extent that trends in the design of MLS gaskets have been toward reductions in numbers of layers used, and particularly in cases where such layers cannot feasibly be reduced, non-metallic stoppers have been employed. Such non-metallic stopper structures have generally been formed as part of, and hence integral to, a central unitary metal spacer layer. Many have been employed in combination with metallic bead structures, often deposited by screen-printing in the troughs or undersides of such beads. The employment of screen-printed, non-metallic beads has, however, been associated with higher expense, and in many cases with less than satisfactory results.

### SUMMARY OF THE INVENTION

The disclosed invention provides a unitary, generally circular stopper bead constructed of an epoxy/metal hard coating material that substantially fills a trough of a metallic bead having a circumferentially variable height and/or width dimension about a combustion aperture of an MLS combustion-sealing gasket. The technique of varying the depth or width of a circumferential metallic bead, rather than varying the depth or width of an applied screen printed bead within the trough of the metallic bead, is deemed to offer a potentially more durable, as well as simpler manufactured, gasket.

The manufacture of one described embodiment of the gasket with a circumferential metallic bead having a varying depth involves use of a progressive die system. The die system is used to create multiple undulations in a direction along an axis of the combustion aperture of the gasket. A set of upper and lower progressive dies are used to first stamp a gasket blank containing at least one pre-formed combustion aperture, and one circumferential metallic stopper bead surrounding the aperture. The bead as initially created includes a trough of a constant depth that is greater than the ultimately highest desired depth in the final trough design. Next, the trough dimension is reduced and circumferentially adjusted by a second set of dies to create a series of undulations that act to compensate for variations of stresses normally occurring about the circumferential aperture or cylinder bore. Such stress variation occurs as a result of irregularities of engine block and mating cylinder head design, and associated spacing about the cylinder bores, as well as the spacing and or positions of cylinder head fastening bolts.

Next, the variable thickness metallic stopper beads are filled with an epoxy/metal hard coating by means of a silk-screening or screen-printing process. As disclosed, the variable height metallic stopper bead and resin structures range in height from about 0.05 mm to 0.20 mm.

Finally, an embossed metallic secondary bead is formed radially outwardly of the already described primary stopper layer formed of a metallic bead with associated resin material. The secondary bead may be formed by a separate holding die even prior to closure of the second undulating or forming die set. The primary and secondary beads are designed to act in concert with each other, wherein the secondary sealing bead provides a backup in case of failure of the primary bead, as well as providing a primary seal against leakage of engine coolant into the combustion chambers of the engine.

### BRIEF DESCRIPTION OF THE DRAWINGS

FIG. 1 is a plan view of a fragmentary portion of one described embodiment of an MLS cylinder head gasket adapted to surround and seal a plurality of engine cylinder bore apertures; this view depicts a sequence of variable thickness dimensions that occur in an integral stopper layer of the gasket.

FIG. 2 is a cross-sectional view of the gasket of FIG. 1, taken along lines 2-2 of FIG. 1.

FIG. 3 is a cross-sectional view of an integral metallic stopper layer of the same gasket, showing a trough-style stopper bead, with a metal/epoxy hard coating material filling a relatively deep trough portion of the stopper bead.

FIG. 4 is a cross-sectional view of another portion of the integral stopper layer of the same gasket, showing the metallic stopper bead filled with the hard coating material in a relatively shallow trough portion of the bead.

FIG. 5 is a cross-sectional view of an integral stopper layer of an alternate embodiment of a similar gasket, showing a stopper bead filled with the hard coating material in a relatively wide trough portion of the stopper bead.

FIG. 6 is a cross-sectional view of the integral stopper layer of FIG. 5, showing the stopper bead filled with the hard coating material in a relatively narrow trough portion of the stopper bead.

### DETAILED DESCRIPTION OF THE EMBODIMENTS

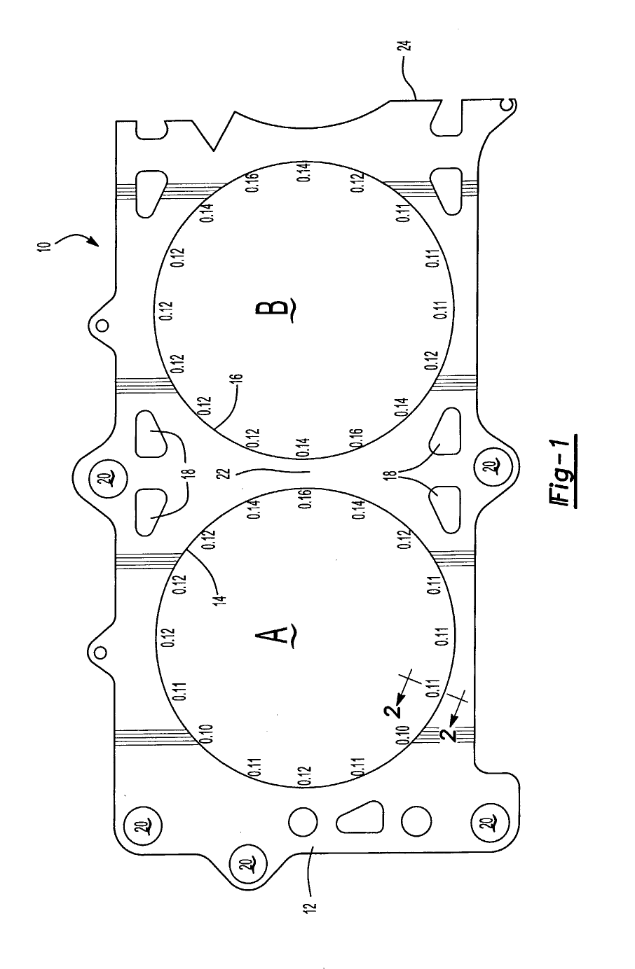

Referring initially to FIG. 1, a fragmentary portion of a metal cylinder head gasket 10 is shown. In the described embodiment, the gasket 10 includes a plurality of steel layers, and is generally referred to as a multi-layered steel (MLS) gasket.

Among significant variables involved in sealing between engine blocks and cylinder heads, a variety of nonlinear variables impact the design of a gasket. Generally, the engine areas and surfaces to be sealed are rarely uniform in size or shape. As a result, the attachment bolt locations are often non-symmetrically arranged or positioned about the areas of the gasket to be secured.

As a result of the described asymmetrical relationships, it is preferable that the stopper layer of a cylinder head gasket provides a constant or uniform pressure pattern about the circumference of each cylinder bore, as opposed to providing a variable pressure thereabout. This invention provides an improved mechanism for assuring that uniform pressure is applied via the stopper layer, in a manner that is both efficient with respect to manufacturing, as well as in a manner designed to avoid premature failure of metallic trough-style stopper beads.

Referring now more specifically to FIG. 1, an end area 12 of the gasket 10 is secured to an area of the engine that is recognized to be relatively stiff compared to other areas positioned along a longitudinal engine block (not shown). A cylinder bore boundary 14 defines a bore aperture A, while a cylinder bore boundary 16 defines an adjacent bore aperture B. The gasket 10 is shown only fragmentarily; thus a jagged boundary 24 is depicted, to the right of which would normally be additional cylinder bore apertures, not shown.

The gasket 10 includes a plurality of apertures in addition to the cylinder bore apertures 14 and 16; thus, aperture 18 comprises a water bore, while apertures 20 represent bolt hole apertures. The several other unnumbered apertures represent oil and bypass gas apertures, as will be appreciated by those skilled in the art.

An area situated between the bore apertures A and B represents a so-called web area 22 in which a relatively wide spacing between bolt apertures 20, coupled with a relatively small area dimension, gives rise to a traditionally difficult sealing issue. Thus, it will be appreciated that to effect a proper seal, desired stopper layer forces may be varied about the cylinder head aperture boundaries 14 and 16. In accordance with the invention, this is achieved by providing a variable thickness in a stopper bead positioned about the apertures. A series of relative thicknesses are shown about the apertures, ranging from 0.05 mm to 0.20 mm. The thicknesses are generally established by design parameters calculated through finite element analysis for each cylinder bore area.

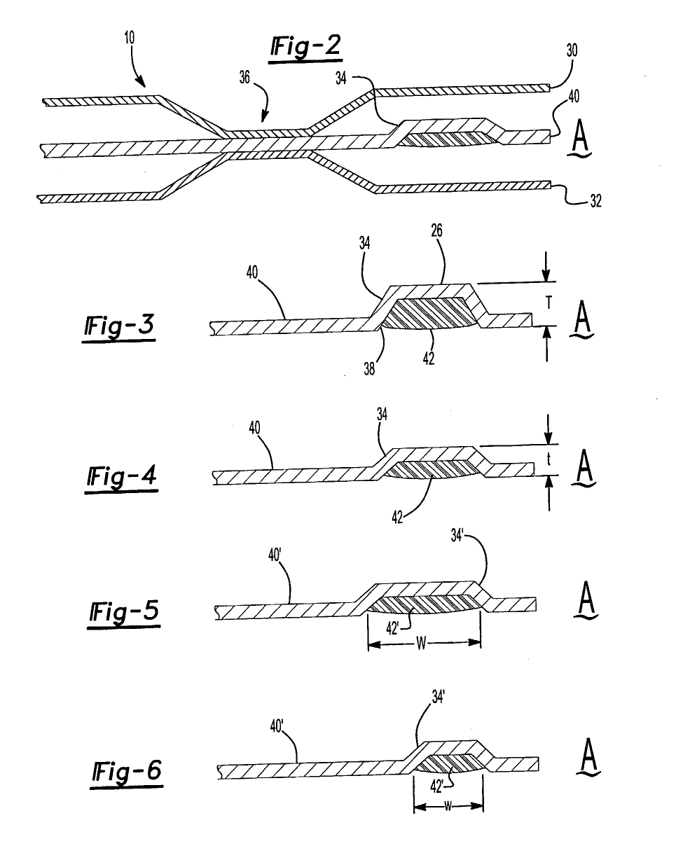

Referring now also to FIG. 2, a cross-sectional view of the gasket 10 is revealed along lines 2-2 of FIG. 1. The gasket 10 is comprised of two external layers; a top or upper embossed layer 30, and a mirror image lower or bottom embossed layer 32. Interposed between the external layers 30 and 32 is an embossed center or spacer layer 40 that contains an asymmetrical metal stopper bead 34. The bead 34 in the described embodiment is a trough-style bead formed in the general shape of a trapezoid. The top 26 of the bead 34 forms a bottom of a bead trough 38. In accordance with one aspect of the invention, an epoxy/metal hard coating stopper bead material 42 is deposited and cured within bead trough 38. Together with the expoxy/metal hard coating bead material 42, the metallic bead 34 acts as a primary combustion bead, circumferentially surrounding the bore A. Further, the primary combustion bead is positioned intermediate the combustion aperture A and a secondary combustion bead 36, as shown.

Those skilled in the art will appreciate that the secondary combustion seal 36 provides a backup to the primary combustion seal 34, as well as a means for preventing engine coolant flow toward the primary combustion seal 34.

Referring now to FIGS. 3 and 4, the center or spacer layer 40 is shown apart from the other gasket layers. The layer 40 includes the described stopper structure, which is embodied in the primary combustion bead 34. In the described embodiment, the secondary combustion bead 36 is formed only in the external layers 30 and 32. Comparing FIGS. 3 and 4, those skilled in the art will appreciate that extremes of the variable or undulating depth of the trough-shaped metal bead 34 are reflected between the two views. Thus, it will be appreciated that the depth indicated as T is the thickest depth representing the fullest stopper thickness of 0.20 mm as earlier indicated. Conversely, the depth t is the shallowest depth, representing the thinnest indicated trough thickness of 0.05 mm (see FIG. 1).

The epoxy/metal hard coating sealing bead material 42 is deposited within the trough 38 so as to substantially fill the trough shaped metallic beads 34. Together, the composite metallic bead 34 and hard coating sealing bead material 42 form the asymmetric composite bead structure shown. To the extent that the beads 34 are varied in thickness, i.e. between thicknesses t and T, it will be apparent to those skilled in the art that the hard coating may be successfully applied by silk-screening to substantially fill the trough-like bead 34. Upon completion of the silk-screening operation, the epoxy/metal is heat-cured, and hardens during the curing. The hardened epoxy/metal may have a slightly convex meniscus over its exposed top surface; resulting in a crescent-shaped cross-section at the portion thereof adapted for making contact with adjacent layers of the gasket.

The effect of filling the trough 38 will avoid undesirable deflection of the bead 34, which happens in prior art arrangements where the troughs are not substantially filled. In such cases, the beads tend to collapse until the level of the top surface of the filler material is reached or contacted by the adjacent gasket layers. To the extent that the movement of layers in a combustion gasket 10 is dynamic, it will be appreciated that successive cycles of deflection of the stopper beads will give rise to bead cracking over relatively short periods of time. Therefore, by varying the depth of the metallic bead 34, the present inventors have discovered a way to avoid such early stopper bead failures, and yet achieve a viable variable thickness stopper bead.

Referring now to FIGS. 5 and 6, an alternate embodiment of a variable bead structure is shown. As shown, the bead 34′ has a relatively constant thickness, but provides a variable width that ranges between w and W about the circumference of the bead 34′. Thus, the inventors believe that providing a variable width of the metal bead 34′, in combination with a substantial filling of the bead trough as in the previously described embodiment, will also be effective to avoid bead cracking issues, while accommodating the variable stress about the cylinder bores of an engine.

For producing both described embodiments of the invention having either a varying depth or a variable width of the circumferential metallic bead, a progressive die is used to create multiple undulations in an area adjacent the combustion apertures of the gasket. A first set of upper and lower progressive dies is used to stamp a gasket blank containing at least one pre-formed combustion aperture, and one circumferential metallic bead surrounding the aperture. The bead as initially created includes a trough of either a) constant depth that is greater than the ultimately highest desired depth in the final bead design, or b) constant width that is greater than the ultimately widest desired width in the final bead design. Next, the bead dimension is reduced and circumferentially adjusted by a second set of dies to create a series of undulations that act to appropriately compensate for variations of stresses normally occurring about the circumferential aperture or cylinder bore. As earlier noted, such stress variations occur as a result of irregularities of engine block and mating cylinder head design, associated spacing about the cylinder bores, and spacing and or positions of cylinder head fastening bolts.

Next, the metallic beads of either variable thickness or width are filled with an epoxy/metal hard coating by means of a silk-screening or screen-printing process. As disclosed, in the case of variable thickness beads, the varying metallic bead and epoxy/metal hard coating structures range in height from 0.05 to 0.20 mm, and the hard coating is deposited so as to substantially fill the bead trough.

Finally, in the described embodiment, the metal employed for the outer layers 30, 32 of the gasket 10 were 301 SAE stainless-steel. The interposed spacer layer 40 was formed of 409 stainless or zinc plated low carbon steel.

It is to be understood that the above description is intended to be illustrative and not limiting. Many embodiments will be apparent to those skilled in the art upon reading the above description. The scope of the invention should be determined, however, not with reference to the above description, but with reference to the appended claims with full scope of equivalents to which such claims are entitled.

What is claimed is:

1. A cylinder head gasket comprising first and second beaded layers of metal; a third layer of metal interposed between said first and second layers; said interposed layer further comprising:
a) a sealing bead defining at least one generally circular undulation and surrounding at least one aperture adapted to be positioned intermediately between said two first and second layers, all of said layers including apertures adapted to be situated in registration with at least one engine cylinder bore;
b) said bead defining a trough positioned on its underside, and a metal/epoxy material substantially filling said trough to present a circumferential composite bead structure about at least one engine bore; and
c) wherein both said trough and said metal/epoxy material comprise a composite structure having a varying undulating height about said bore, so as to provide sealing pressures about said bore to compensate for varying load differentials about the circumference of the bore.

2. The cylinder head gasket of claim 1 wherein said interposed layer comprises a substantially planar body, wherein said composite structure of said bead comprises said trough portion containing said metal/epoxy hard coating; and wherein further said trough and metal/epoxy hard coating material comprises at least one asymmetrical stopper portion of said gasket upon installation of said gasket in an engine.

3. The cylinder head gasket of claim 2 wherein said stopper has a generally convex meniscus-shaped exposed top surface portion of said gasket adapted for contact with said first and second layers when the gasket is secured in place about a combustion aperture.

4. The cylinder head gasket of claim 2 wherein said composite structure ranges in height from about 0.05 mm to 0.20 mm about the circumferential extent of said layer.

5. The cylinder head gasket of claim 1 wherein said combination metallic bead and metal/epoxy hard coating material comprise an asymmetrical circular bead on said interposed layer.

6. The cylinder head gasket of claim 1, wherein said first and second beaded outer layers are mirror image of one another.

7. A gasket comprising at least one metal layer including a generally circular undulating metallic bead, said metallic bead adapted to be positioned about a bore formed in said metal layer; said bead comprising a circumferentially extending trough defining the underside of said bead, and a metal/epoxy hard coating material substantially filling said trough to define a circumferential bead of said metal/epoxy hard coating material; wherein said trough and said metal/epoxy hard coating material define a composite bead structure have a varying undulating height about the circumference of said composite bead so as to provide sealing pressures about the bore to compensate for varying load differentials about the circumference of said bore.

8. The gasket of claim 7 wherein said composite bead structure is an asymmetrical structure.

9. The gasket of claim 7 wherein said layer comprises a stainless steel material.

10. The gasket of claim 7 wherein said layer further includes an embossed secondary bead circumferentially positioned radially outwardly of said composite bead structure.

11. A cylinder head gasket comprising first and second beaded layers of metal; a third layer of metal interposed between said first and second layers; said interposed layer further comprising:
a) a sealing bead having a substantially uniform thickness and surrounding at least one aperture adapted to be positioned intermediately between said two first and second layers, all of said layers including apertures adapted to be situated in registration with at least one engine cylinder bore;
b) said bead defining a trough positioned on its underside, and a metal/epoxy material substantially filling said trough to present a circumferential composite bead structure about at least one engine bore; and
c) wherein both said trough and said metal/epoxy material comprise a composite structure having a varying width about said bore, so as to provide sealing pressures about said bore to compensate for varying load differentials about the circumference of the bore.

12. The cylinder head gasket of claim 11 wherein said interposed layer comprises a substantially planar body, wherein said composite structure of said bead comprises said trough portion containing said metal/epoxy hard coating; and wherein further said trough and metal/epoxy hard coating material comprises at least one asymmetrical stopper portion of said gasket upon installation of said gasket in an engine.

13. The cylinder head gasket of claim 12 wherein said stopper has a generally convex meniscus-shaped exposed top surface portion of said gasket adapted for contact with said first and second layers when the gasket is secured in place about a combustion aperture.

14. The gasket of claim 11 wherein all of said layers are constructed of a stainless steel material.

15. The gasket of claim 11 wherein all of said layers further includes an embossed secondary bead circumferentially positioned radially outwardly of said stopper.

16. The gasket of claim 11, wherein said first and second beaded outer layers are mirror images of one another.
